(19) United States
(12) Patent Application Publication
(10) Pub. No.: US 2019/0054907 A1
(43) Pub. Date: Feb. 21, 2019

(54) METHOD FOR ESTIMATING AN AXLE LOAD DISTRIBUTION IN A ROAD TRAIN

(71) Applicant: KNORR-BREMSE SYSTEME FUER NUTZFAHRZEUGE GMBH, Muenchen (DE)

(72) Inventors: Attila Skrabak, Budapest (HU); Jozsef Sonfeld, Budapest (HU); Laszlo Simon, Budapest (HU); Gyorgy Juhasz, Budapest (HU); Gabor Bozsvari, Budapest (HU); Zsolt Szalay, Budapest (HU); Gyorgy Cserhalmi, Budapest (HU); Istvan Baksa, Zalaveg (HU)

(21) Appl. No.: 15/761,521

(22) PCT Filed: Sep. 6, 2016
(86) PCT No.: PCT/EP2016/070907

§ 371 Date: Mar. 20, 2018

(30) Foreign Application Priority Data
Sep. 21, 2015 (DE) 10 2015 115 852.3

(51) Int. Cl. B60T 8/1766; B60T 8/18; B60T 8/17

(52) U.S. Cl. CPC B60T 8/1766; B60T 8/30; B60T 8/1708; B60T 8/1887

(57) ABSTRACT

A method for estimating an axle load distribution in a road train, including: ascertaining at least one load on an axle of the road train using a slip value and a force value, in which the slip value represents a slip between the axle and a further axle of the road train and the force value represents a tractive or decelerating force at the axle. Also described are a related apparatus and a computer readable medium.

### FIELD OF THE INVENTION

The present invention proceeds from a generic apparatus or a generic method according to the independent claims. The subject matter of the present invention also relates to a computer readable medium.

### BACKGROUND INFORMATION

Knowledge of an axle load distribution is required in a road train in order to be able to provide adapted braking torques at the individual axles. The axle load distribution can be captured using load sensors at the axles. If the axle load sensors fail, it is difficult to obtain the intended braking force distribution.

Against this background, the approach presented here presents a method for estimating an axle load distribution in a road train, furthermore an apparatus using this method and, finally, a corresponding computer program according to the main claims. Advantageous developments and improvements of the apparatus specified in the independent claim are possible as a result of the measures stated in the dependent claims.

If the axle load sensors have failed and/or in the case of vehicles without such sensors, the load on the respective axle can be captured using secondary physical variables. Since the load on the axle compresses the pneumatic tires of the wheels of the axle, an effective rolling radius of the wheels changes depending on the load. The modified rolling radius of a wheel is mapped onto a modified rotational speed of the wheel. The rotational speed can easily be captured by way of ABS sensors, for example.

The rotational speed is additionally influenced by torques acting on the wheel and by a slip of the pneumatic tires caused by the torques.

In the approach presented here, the influences by the torques are used to deduce the load.

A method for estimating an axle load distribution in a road train is presented, wherein the method has a step of ascertainment, in which at least one load on an axle of the road train is ascertained using a slip value and a force value, wherein the slip value represents a slip between the axle and a further axle of the road train and the force value represents a tractive or decelerating force at the axle.

A road train can be understood to mean a vehicle combination, consisting of a truck as a towing vehicle and a trailer as a towed vehicle or a semitrailer tractor as a towing vehicle and a semitrailer as a towed vehicle. A load can be a normal force, i.e. a weight acting perpendicular to a contact area. A slip value can map a difference between a rotational speed of the considered axle and a second rotational speed at a reference axle.

Further, the load can be ascertained using a freewheeling slip value. The freewheeling slip value represents the slip between the axle and the further axle when the force on both axles is less than a threshold value. The freewheeling slip value is not influenced by the tractive or decelerating force. The freewheeling slip value may be stored in a memory. The freewheeling slip value can be ascertained when no tractive or decelerating force acts.

The method may have a step of capture, in which a first vehicle state and at least one second vehicle state are captured during the operation of the road train. A first slip value and a first force value are captured in the first vehicle state. A second slip value and a second force value are captured in the second vehicle state. The freewheeling slip value can be determined using the first vehicle state and the second vehicle state. It is possible to describe a relationship between the slip and the force by way of at least two points at different vehicle states. The freewheeling slip can be deduced from the relationship, said freewheeling slip substantially being dependent on the wheel diameter differences.

The second vehicle state can be captured if a difference between a right wheel speed value of the axle and a left wheel speed value of the axle is less than a limit value between the first vehicle state and the second vehicle state. The difference is less than the limit value if the road train drives in a straight line and the difference is only caused by different pneumatic tire pressures and/or tire wear. In the ideal case, the difference is close to zero.

The second vehicle state can be captured if the slip increases or falls monotonically between the first vehicle state and the second vehicle state. In the case of a monotonically increasing or falling slip, the slip either increases or decreases.

The second vehicle state an be captured if the force value increases or falls monotonically between the first vehicle state and the second vehicle state. In the case of a monotonically increasing or falling force value, the force value either increases or decreases.

The second vehicle state can be captured if the monotonic state ends. In particular, the second vehicle state can be captured if the slip no longer monotonically increases or falls, or if the force value no longer monotonically increases or falls.

The load can further be ascertained using a slip stiffness value of the axle. The slip stiffness value represents slip stiffnesses of wheels of the axles. A slip stiffness maps the flexibility of the pneumatic tires, as a result of which the tires have a slip on account of a torque load. The force value can be converted into a traction slip or a brake slip by way of the slip stiffness value.

By way of example, this method can be implemented in software or hardware or in a mixed form of software and hardware, for example in a controller.

The approach presented here further provides an apparatus embodied to carry out, actuate or implement the steps of the variant of a method, presented here, in appropriate devices.

The problem underlying the invention can also be solved quickly and efficiently by this embodiment variant of the invention in the form of an apparatus.

In the present case, an apparatus can be understood to mean an electrical appliance which processes sensor signals and, dependent thereon, outputs control and/or data signals. The apparatus may have an interface that can be embodied in terms of hardware and/or software. In the case of an embodiment in terms of hardware, the interfaces may be part of a so-called system ASIC, for example, the latter containing very different functions of the apparatus. However, it is also possible for the interfaces to be dedicated integrated circuits or at least in part consist of discrete components. In the case of an embodiment in terms of software, the interfaces may be software modules which are present, for example, on a microcontroller in addition to other software modules.

A computer program product or computer program with program code, which may be stored on a machine-readable carrier or storage medium such as a solid-state memory, a fixed-disk storage or optical storage and which is used to carry out, implement and/or actuate the steps of the method according to any one of the embodiments described above is also advantageous, in particular if the program product or program is executed on a computer or an apparatus.

### BRIEF DESCRIPTION OF THE DRAWINGS

FIG. 1 shows an illustration of a road train having a module for estimating an axle load distribution according to one exemplary embodiment.

FIG. 2 shows an illustration of a semitrailer train having a module for estimating an axle load distribution according to one exemplary embodiment.

FIG. 3 shows a block diagram of a system for estimating an axle load distribution according to one exemplary embodiment.

FIG. 4 shows a flowchart of a method for estimating an axle load distribution according to an exemplary embodiment.

### DETAILED DESCRIPTION

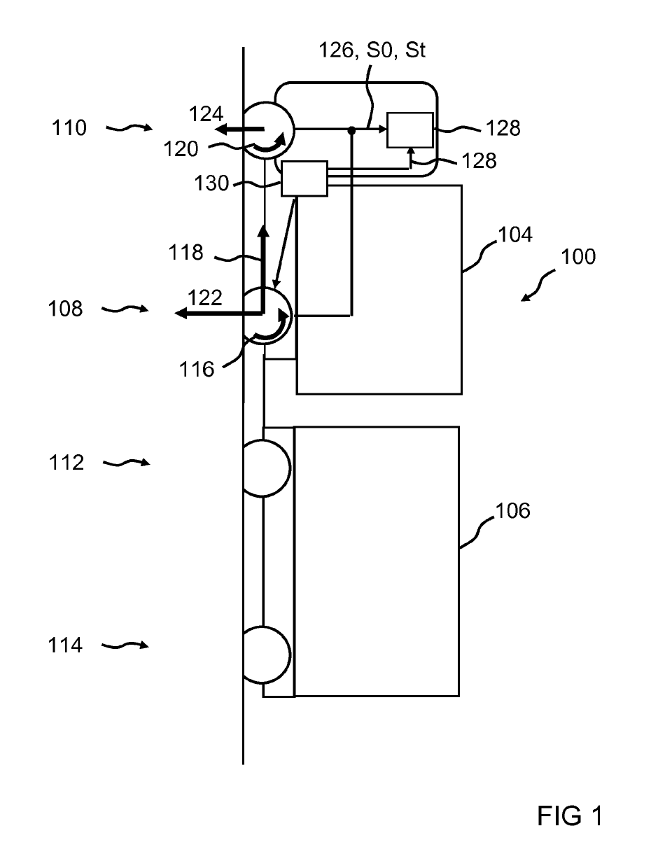

FIG. 1 shows an illustration of a road train 100 having a module 102 for estimating an axle load distribution according to one exemplary embodiment. The module 102 may also be referred to as apparatus 102. The module 102 is a constituent part of an electronic brake system of the road train 100. The road train 100 consists of a tractor 104 or a towing vehicle 104 and a trailer 106 in this case. The tractor 104 is a truck 104 and has a load floor for transporting some of the load of the road train. The rest of the load is transported on the trailer 106. The tractor 104 has a driven drive axle 108 or rear axle 108 and a non-driven, steered axle 110 or front axle 110. The trailer 106 has a steered fifth wheel 112 and a rigid rear axle 114. The fifth wheel 112 is connected to a trailer coupling of the tractor 104 by way of a drawbar.

The drive axle 108 of the truck 104 is connected to a drive train of the truck 104. By way of the drive train, a driving torque is transferred to the drive axle 108. The wheels of the drive axle 108 are set into rotation 116 by way of the torque. As a result of the rotation 116, the wheels roll over the ground and this results in a tractive force 118 at the drive axle 108.

The axle 110 is not connected to the drive train. The wheels of the axle 110 are set into rotation 120 by the movement of the road train 100.

The road train 100 has brakes at all axles. During a brake procedure, a decelerating force, not illustrated here, act on all axles. The decelerating force acts counter to the tractive force.

The wheels of the road train 100 have pneumatic tires. The tires are deformed by a load on the axles 108, 110, 112, 114 such that they carry out a flexing movement during the rotation 116, 120. Here, a degree of the deformation depends on a load 122, 124 on the individual axle 108, 110. Different rolling radii emerge as a result of the deformation.

On account of different rolling radii, different rotational speeds 116, 120 emerge at the wheels of the axles 108, 110 at an overall speed of the road train 100. Additionally, the flexible tires at the driven axle 108 are deformed further by the driving torque. The driving torque results in a traction slip. The extent to which the tires deform under the torque can be mapped by a slip stiffness value. If no driving torque acts, the different rotational speeds 116, 120 result in a freewheeling slip. Together, the traction slip and the freewheeling slip yield an overall slip. The overall slip can be measured by capturing the rotational speeds 116, 120.

The module 102 is embodied to estimate an axle load distribution of the road train 100. To this end, the module 102 has an ascertainment device which ascertains at least the load 122 on the drive axle 108 using a slip value 126 and a force value 128. The slip value 126 represents the overall slip between the drive axle 108 and the front axle 110. The force value 128 represents the tractive force 118 at the drive axle 108 or the decelerating force. By way of example, the slip value 126 is determined in a vehicle controller, not illustrated here, using the rotational speeds 116, 120. The force value 128 is provided by a controller 130 of the drive train in this case. By way of example, the force value 128 can be derived from a currently provided drive power.

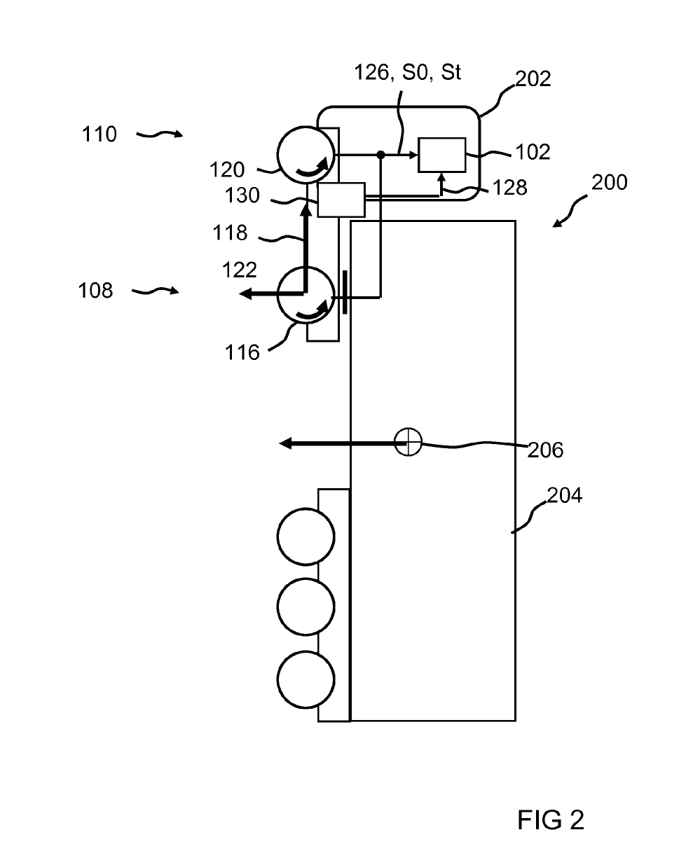

FIG. 2 shows an illustration of a semitrailer train 200 having a module 102 for estimating an axle load distribution according to an exemplary embodiment. The illustration substantially corresponds to the illustration in FIG. 1. The semitrailer train 200 consists of a semitrailer tractor 202 and a semitrailer 204. In the case of the semitrailer train 200, the whole load is transported on the semitrailer. The semitrailer tractor 202 does not have a dedicated load floor. A weight component of the load is supported by the semitrailer tractor 202.

Like in FIG. 1, the module 102 is embodied to estimate an axle load distribution of the semitrailer train 200. To this end, the module 102 has the device for ascertainment, which ascertains at least the load 122 on the drive axle 108 using a slip value 126 and a force value 128. Since the semitrailer tractor does not have a dedicated payload, the load 122 arises from a center of mass position 206 of the load in this case.

FIGS. 1 and 2 show schematic illustrations of an axle load estimate based on traction slip or brake slip.

Using the approach presented here, it is possible to estimate a load state of the vehicle combination 100, 200. If the towing vehicle 104, 202 is a tractor 202, a position of the center of mass 206 of the load of the semitrailer 204 is estimated. If the towing vehicle 104, 202 is a truck 104, a payload of the towing vehicle 104 is estimated. The load state is not estimated if it can be derived from a well-estimated overall mass of the overall vehicle 100, 200. In this case, a slip stiffness of the driven axles is learned by way of the axle load estimate based on traction slip.

Furthermore, the load of the towing vehicle 104, 202 can be learned if a trailer 106, 204 is connected to the vehicle 104, 202 and no axle load sensor is present. Knowledge about the load situation of the tractor 104, 202 is required in order to ascertain a brake pressure distribution between the parts of the road train 100 or between axles 108, 110 of the towing vehicle 104, 202. The function presented here estimates the load 122 on the basis of the wheel speed ratios between axles 108, 110, which are measured by wheel speed sensors, if the wheel speed ratio corresponds to the slip of the axles 108, 110.

Axle slip s 126 denotes a measured relative speed difference between two axles 108, 110. The axle slip 126 is composed of a freewheeling slip s₀ and a traction slip sₜ.

The freewheeling slip Sₒ is a relative speed difference between two axles 108, 110 when no tractive force 118 or braking force acts on the wheels of the considered axles 108, 110.

This is not a physical slip, but the speed difference is caused by travels of different length or by uneven rolling conditions.

The traction slip Sₜ is a relative speed difference between a freewheeling axle 110 and a driven axle 108 and is produced by a drive torque of the driven axle 108.

An axle lateral slip sₐₓₗₑₗᵣ is a relative speed difference of the two wheels of an axle 108, 110.

The tractive force F_{longitudinal} 118 is the sum of the wheel forces at the considered driven axle 108, which is only produced by the accelerating torque.

The tractive force 118 is monitored and limited by an automatic traction controller. In the meantime, the minimum tractive force 118 is stored and half the value of the minimum is subsequently used as the tractive force limit for the traction controller. This limit is increased with predefined increments, e.g. with 50 N/s, if no tractive force restriction sets in and the actual tractive force 118 is greater than this limit.

The normal force Fₙₒᵣₘₐₗ 122 is the force component acting perpendicular to the road between the road and the considered drive axle 108.

The wheel slip stiffness is calculated as follows:

$${T}_{SS} = \frac{{F}_{longitudin al}}{{F}_{normal} \cdot {s}_{t}}$$

It is possible to carry out a differential slip search. The estimates of the dynamic load 122 on the driven axle 108 and of the slip stiffness of the driven axle 108 are based on the search for slip/tractive force point pairs.

The goal of the differential slip search is to find two vehicle states in which the traction slip increases monotonically between the two vehicle states, the tractive force 118 increases monotonically between the two vehicle states, no effective brake pressure acts, the tractive force 118 is not restricted by the traction controller, the actual tractive force 118 lies below the tractive force limit of the traction controller and the axle lateral slip is constant for the considered driven axle 108 and the reference axle 110. This condition ensures that the radius of curvature of the vehicle 100, 200 is constant and that no driven wheel spins during the difference search. Additionally, there should be at least one predefined minimal difference, for example 0.5%, in the traction slip and a predefined minimum difference in the tractive force 118, for example 500 N, between the two vehicle states. The second vehicle state can be assumed when the monotonic property of the traction slip or of the tractive force 118 ends or if there is a change in the axle lateral slip.

The search starts from the beginning if no tractive force 118 or a negative tractive force 118 is measured or if the actual tractive force 118 is less than a third of the last-found load maximum. The traction slip of the first vehicle state is interpolated/extrapolated to zero if a zero crossing of the tractive force 118 is found. If no zero crossing of the tractive force 118 is found and if an externally calculated freewheeling slip s₀ is present, the latter is used instead of the interpolated/extrapolated traction slip.

After successful differential slip search, the freewheeling slip s₀, which arises without tractive force 118, the axle slip s, which arises at a higher towing force, and the higher towing force F_{longitudinal} are known. With the likewise known slip stiffness, it is possible to calculate the actual dynamic axle load 122 on the driven axle 108:

$${F}_{normal} = \frac{{F}_{longitudin al}}{{T}_{SS} ( s - {s}_{0} )}$$

This calculation is carried out if the quality of an axle load estimate based on the overall mass is less than a preconfigured threshold value. Otherwise, the axle load estimate based on the traction slip estimates the slip stiffness of the tires. The dynamic load estimate for the driven axle uses the estimated tire slip stiffness. If it is not available, use is made of a preconfigured slip stiffness. In the case of a tire change at a driven axle 108, use is likewise made of the preconfigured slip stiffness.

There is a load estimate at the towing vehicle 104 or an estimate of a load position 206 on the semitrailer 204.

If the vehicle 104, 202 is a truck 104 and the actual dynamic load 122 on a driven axle 108 is estimated, the load of the tractor 104 is estimated by calling the inverted vehicle model. The inverted vehicle model calculates unknown vehicle parameters, in this case the load of the towing vehicle 108, using a Newton Raphson method with the use of the known parameters. The moving average of the weighted inverse vehicle model is the result of the estimate of the load of the towing vehicle 104 if the weight is proportional to the differential slip that is the basis of the actual dynamic axle load estimate. If a change in the payload is identified, the moving average calculation is restarted.

If the vehicle type is a tractor 202 and the actual dynamic load 122 on a driven axle 108 is estimated, the load position 206 of the trailer 204 is estimated by calling the inverted vehicle model. The inverted vehicle model calculates the unknown vehicle parameter, in this case the load position 206 of the trailer 204, using a Newton Raphson method with the use of the known parameters. The moving average of the weighted inverse vehicle model is the result of the estimate of the semitrailer load position 206 if the weight is proportional to the differential slip that is the basis of the actual dynamic axle load estimate. If a change in the payload is identified, the moving average calculation is restarted.

The slip stiffness of the driven axles 108 is calculated if the load distribution of the vehicle 104, 202 is calculated with a high quality by the overall-mass-based axle load estimate. As a result, the dynamic normal forces Fₙₒᵣₘₐₗ 122 of the driven axle 108 are also calculated by the vehicle model. Estimating the slip stiffness of the driven axle 108 is based on the following equations, which are based on the two vehicle states from the differential slip search:

$${s}_{{t}_{1}} = {s}_{1} - {s}_{0} = \frac{{F}_{longitudin {al}_{1}}}{{T}_{SS} \cdot {F}_{{normal}_{1}}} ;$$

$${s}_{{t}_{2}} = {s}_{2} - {s}_{0} = \frac{{F}_{longitudin {al}_{2}}}{{T}_{SS} \cdot {F}_{{normal}_{2}}}$$

The difference of the two equations is:

$${s}_{1} - {s}_{2} = \frac{{F}_{longitudin {al}_{1}}}{{T}_{SS} \cdot {F}_{{normal}_{1}}} - \frac{{F}_{longitudin {al}_{2}}}{{T}_{SS} \cdot {F}_{{normal}_{2}}}$$

Thus, the slip stiffness can be calculated from the two vehicle states of the differential slip search:

$${T}_{SS} = \frac{{F}_{longitudin {al}_{1}}}{( {s}_{1} - {s}_{2} ) \cdot {F}_{{normal}_{1}}} - \frac{{F}_{longitudin {al}_{2}}}{( {s}_{1} - {s}_{2} ) \cdot {F}_{{normal}_{2}}}$$

The moving average of the weighted slip stiffness Tₛₛ is the result of the semitrailer load position estimate, in which the weight is proportional to the differential slip basis of the actual dynamic axle load estimate. If a tire change is detected, the moving average estimate is restarted. The learned slip stiffnesses are stored in an EPROM in order to be available for future dynamic load estimates at the driven axles.

The relationship between axle pair speed ratios 126 under load is dependent on a known vehicle geometry, braking factors and an unknown slip stiffness. The load estimate uses this relationship to determine the load. In order to do this, the function determines the unknown slip stiffnesses using the same relationships in the reverse order if a load is assumed to be known.

The function presented here is a passive observer which has the advantage over active regulation solutions, such as the slip control, for example, that it facilitates the regulation of the braking pressure by independent functions, such as wear monitoring.

The relationship between the load and the wheel speed ratios 126 is mapped in the dynamic model of the vehicle 104, 202. The function solves this relationship in each problem cycle, for example every 20 ms. Since the dynamic model is too complex to be solved analytically, it is solved by a numerical Newton Raphson function which is an interactive root finding algorithm for scalar-scalar functions.

The algorithm searches for the value of the parameter to be learned, at which the vehicle model outputs the same wheel speed ratios 126 as are at the vehicle 104, 202 measured at the considered instant.

There is a learning phase. The parameter estimate is performed during driven phases at driven axles 108. The parameter estimate is performed during braking phases at freewheeling or non-driven axles 110. The estimate is interrupted if the tangential wheel force is less than a threshold value, for example 2000 Newton.

It is possible to estimate a parameter in each case. The estimated parameter can be slip stiffness if the load conditions are assumed to be known. The estimated parameter can be a load 122 on the towing vehicle if a trailer 106, attached via the drawbar, is connected and the load conditions are not known. The estimated parameter can be an axial center of mass position 206 of a semitrailer 204 if a semitrailer 204 is connected and the load conditions thereof are not known.

Slip stiffnesses are learned axle-by-axle if the load conditions are assumed to be known. This is the case if the estimate quality of the overall-mass-based axle load estimate component reaches a predefined threshold value, for example 95%. The estimate quality of the overall-mass-based axle load estimate component depends on the estimate quality of the overall vehicle mass and the conditions which determine how well the load condition of the tractor can be derived from the overall vehicle mass.

The following logic is used: the load condition is known if the vehicle 104, 202 drives on its own and the overall vehicle mass is known. The load condition is known if the road train 100, 200 is a truck 104 with an attached trailer 106 and both vehicle parts 104, 106 are empty. The load conditions are known if the attached trailer 106 is either a drawbar-towed trailer 106 or a semitrailer 204, equipped with an electronic brake system on the trailer, and the trailer 106, 204 axle loads are present via the CAN bus of the trailer and the vehicle overall mass is known.

The slip stiffness depends on a tire type or tire state. Therefore, the learned slip stiffness is reset to a predefined value if a tire change is identified.

In order to learn the load or the load state, the previously learned slip stiffnesses are required. The predefined values are used until these slip stiffnesses are learned. In the case of a truck 104 with an attached trailer 106, the load on the tractor 104 is learned. In the case of a tractor 202 with a semitrailer 204, the axial distance of the center of mass 206 from the kingpin is learned. The reason for this is that the tractor 202 itself does not have any payload. The tractor 202 is loaded by the semitrailer 204. This type of payload is not constant and depends on the vehicle dynamics. Therefore, it cannot be used as a vehicle parameter.

The load estimate is relatively quick since the driven phases are also taken into account. Therefore, the load state is learned in each ignition cycle and it is reset if a change in load is detected.

There is an output of filtering and quality. All these learned parameters are virtually constant. Therefore, the current estimates of these parameters are filtered axle by axle together with weighted first order Lagrange filters in order to obtain stable estimates for each parameter. The weighting of the individual estimates depends on its variance.

The quality of the estimate is based on statistical calculations. The variances of the main input variables are provided by the responsible components. In the case of learning the slip stiffness, a variance of the estimated slip stiffness emerges. A variance of the estimated wheel diameter emerges when learning both the slip stiffness and the load. In the case of learning the load, a variance of the load of the towing vehicle 104, 202 arises. These variances are propagated through the vehicle model. Hence, the theoretical variance of the estimate of the load or of the center of mass 206 in each estimate cycle can be called and both are dependent on the variance of the slip stiffnesses, which are used for the load estimate.

These instantaneous variances are filtered into a common value together with the estimated parameter value filters. In this way, the theoretical variance of the learned points of various estimators, such as an overall-mass-based estimator, a brake-slip-based estimator and a traction-slip-based estimator, is known. The variance of the estimated value of an estimator emerges therefrom:

$$Var ( estimation ) = \frac{Var ( collection )}{n}$$

Here, n is the number of captured points.

What emerges naturally from this method is that points with a higher uncertainty or a higher variance have less effect on the final result. The different estimates are coordinated in a final estimate. The final estimate is based on the ratio of the number of captured points and the estimate variance. The higher this value, the higher the weighting of the axle estimate.

The coordinated final estimate variance the estimates is produced in two steps. First, the final estimate variance is combined as a weighted average; then the estimated variance is corrected by the variance of the variance produced by the various principal components of the various estimates.

After the statistical calculation, a final estimated parameter and its variance are available. A quality is calculated from this estimate variance. To this end, use is made of a confidence interval, which represents 1500 kg payload or half a meter of center of mass displacement, for example. In practical terms, this means that the estimate quality is 68.3% if the estimate variance equals the confidence interval.

Each learned slip stiffness is stored in an EPROM in order to be available in future ignition phases. Further learning cycles of the load or of the load state can be carried out on the basis of these stored slip stiffnesses. Learned payloads are not stored.

The estimated parameters only adapt slowly to changes in the payload or the slip stiffness on account of strong output filters. In order to learn significant changes quickly, for example as a result of a tire change or a change in payload, the filters are restarted in certain situations. The payload estimate starts anew with each ignition or when a load change identification module signals a change in load. The slip stiffness estimate starts anew if a tire change is identified on any axle.

A functional EEPROM is required for the approach presented here. Furthermore, the approach presented here is interrupted during cornering in order to exclude errors on account of various lateral slips. Likewise, the approach presented here is only carried out above a minimum speed in order to prevent learning below an air gap speed.

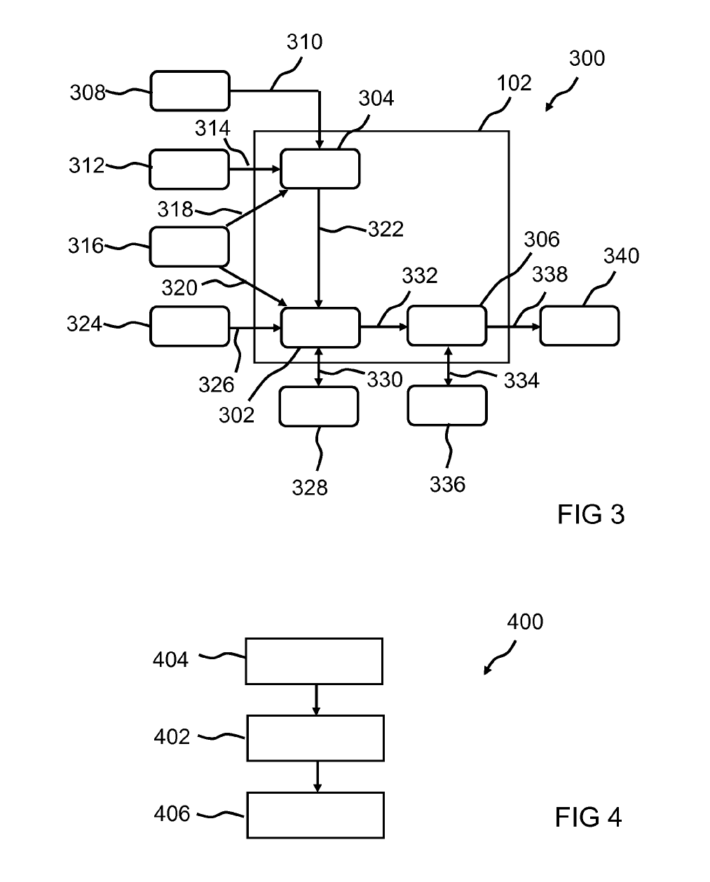

FIG. 3 shows a block diagram of a system 300 for estimating an axle load distribution according to one exemplary embodiment. The module 102, as illustrated in FIGS. 1 and 2, for example, is a constituent part of the system 300. Here, the module 102 has an ascertainment device 302, a learning-phase coordinator 304 and an output filter 306. The illustrated system 300 comprises further modules here. A load change identification module 308 provides a load change information item 310 for the learning-phase coordinator 304. A wheel diameter compensation module 312 provides a tire change information item 314 for the learning-phase coordinator 304. An overall mass estimator module 316 provides a quality information item 318 for the learning-phase coordinator 304. Furthermore, the overall mass estimator module 316 provides an overall mass information item 320 for the ascertainment device 302. The learning-phase coordinator 304 provides a control information item 322 for the ascertainment device 302 using the load change information item 310, the tire change information item 314 and the quality information item 318. A wheel speed filter module 324 provides a wheel speed information item 326 for the ascertainment device 302. The ascertainment device 302 is embodied to calculate or solve a vehicle model 328. To this end, parameters 330 of the vehicle model 328 are adapted and unknown parameters are estimated. Here, the parameters 330 comprise a load, slip stiffnesses and the wheel speed information item 326. The estimated parameters 332 are filtered by the output filter 306. The output filter 306 provides a filtered slip stiffness information item 334 for a storage 336. Furthermore, the output filter 306 provides a filtered load information item 338 for a load coordination module 340.

FIG. 4 shows a flowchart of a method 400 for estimating an axle load distribution according to one exemplary embodiment. By way of example, the method 400 can be carried out on a module as illustrated in the preceding figures. The method 400 has a step 402 of ascertainment. In the step 402 of ascertainment, at least one load on an axle of the road train is ascertained using a slip value and a force value. Here, the slip value represents a slip between the axle and a further axle of the road train. The force value represents a tractive or decelerating force at the axle.

In one exemplary embodiment, the step 402 of ascertainment is preceded by a step 404 of capture. In the step 404 of capture, the force value and the slip value are captured at the road train. In particular, at least two different value pairs of respectively one force value and one slip value are captured. Using the value pairs, a freewheeling slip value is determined, for example by way of an extrapolation, said slip value representing the slip without a tractive or decelerating force. The freewheeling slip value is used in the step 402 of ascertainment in order to ascertain the load.

In the step 404 of capture, it is possible to capture the value pairs when the respective force value and, in an alternative or complementary manner, the respective slip value meet certain criteria. By way of example, capturing can be interrupted during cornering of the road train in order to obtain usable slip values. Likewise, it is possible to predetermine a minimum difference in the slip value and/or in the force value between the value pairs. Here, it is also possible to predetermine that the slip value and/or the force value increases or falls monotonically between the considered value pairs. In particular, the second value pair can be captured when the slip value and/or the force value stops increasing or falling monotonically.

In one exemplary embodiment, the method 400 has a step 406 of use following the step 402 of ascertainment. In the step 406 of use, the ascertained load on the individual axle is used to distribute a braking force of the road train. Hence, it is possible to brake a strongly loaded axle more strongly than a weakly loaded axle, for example, without the wheels of the axles blocking differently during a braking process. Thus, the road train can be braked with the shortest possible braking distance.

The list of reference signs is as follows:
100 Road train
102 Estimation module
104 Tractor, truck
106 Towed vehicle, trailer
108 Drive axle
110 Front axle
112 Trailer front axle
114 Trailer rear axle
116 Rotational speed of the drive axle
118 Tractive force
120 Rotational speed of the front axle
122 Load, normal force
124 Front axle load
126 Slip value
128 Force value
130 Controller
200 Semitrailer train
202 Semitrailer tractor
204 Semitrailer
206 Center of mass position
300 Estimation system
302 Ascertainment device
304 Learning-phase coordinator
306 Output filter
308 Load change identification module
310 Load change information item
312 Wheel diameter compensation module
314 Tire change information item
316 Overall mass estimator module
318 Quality information item
320 Overall mass information item
322 Control information item
324 Wheel speed filter module
326 Wheel speed information item
328 Vehicle model
330 Parameter
332 Estimated parameter
334 Slip stiffness information item
336 Storage
338 Load information item
340 Load coordination module
400 Estimation method
402 Step of ascertainment
404 Step of capture
406 Step of use

1-10. (canceled)

11. A method for estimating an axle load distribution in a road train, the method comprising:
ascertaining at least one load on an axle of the road train using a slip value and a force value;
wherein the slip value represents a slip between the axle and a further axle of the road train and the force value represents a tractive or decelerating force at the axle.

12. The method of claim 11, wherein the load is further ascertained using a freewheeling slip value in the ascertaining, wherein the freewheeling slip value represents the slip between the axle and the further axle when the force on the axle and the further axle is less than a threshold value.

13. The method of claim 12, further comprising:
capturing a first vehicle state and at least one second vehicle state during operation of the road train, wherein a first slip value and a first force value are captured in the first vehicle state and a second slip value and a second force value are captured in the second vehicle state, and wherein the freewheeling slip value is determined using the first vehicle state and the second vehicle state.

14. The method of claim 13, wherein the second vehicle state is captured in the capturing if a difference between a right wheel speed value of the axle and a left wheel speed value of the axle is less than a limit value between the first vehicle state and the second vehicle state.

15. The method of claim 13, wherein the second vehicle state is captured in the capturing if the slip increases or falls monotonically between the first vehicle state and the second vehicle state.

16. The method of claim 15, wherein the second vehicle state is captured in the capturing if the force value increases or falls monotonically between the first vehicle state and the second vehicle state.

17. The method of claim 15, wherein the second vehicle state is captured in the capturing if the monotonic state ends.

18. The method of claim 11, wherein the load is further ascertained using a slip stiffness value of the axle in the ascertaining, wherein the slip stiffness value represents slip stiffnesses of wheels of the axle.

19. An apparatus for estimating an axle load distribution in a road train, comprising:
an ascertaining device to ascertain at least one load on an axle of the road train using a slip value and a force value;
wherein the slip value represents a slip between the axle and a further axle of the road train and the force value represents a tractive or decelerating force at the axle.

20. A computer readable medium having a computer program, which is executable by a processor, comprising:
a program code arrangement having program code for estimating an axle load distribution in a road train, by performing the following:
ascertaining at least one load on an axle of the road train using a slip value and a force value;
wherein the slip value represents a slip between the axle and a further axle of the road train and the force value represents a tractive or decelerating force at the axle.
